(19) United States
(12) Patent Application Publication
(10) Pub. No.: US 2022/0410600 A1
(43) Pub. Date: Dec. 29, 2022

(54) PRINTER

(71) Applicant: FUJITSU COMPONENT LIMITED, Tokyo (JP)

(72) Inventors: Yuji Yada, Shinagawa (JP); Tatsuya Oguchi, Shinagawa (JP); Masafumi Chiba, Shinagawa (JP); Youichi Takamura, Shinagawa (JP); Tetsuhiro Ishikawa, Shinagawa (JP)

(21) Appl. No.: 17/807,499

(22) Filed: Jun. 17, 2022

(30) Foreign Application Priority Data
Jun. 28, 2021 (JP) 2021-106962

(51) Int. Cl. B41J 11/70; B41J 11/66

(52) U.S. Cl. CPC B41J 11/706; B41J 11/663

(57) ABSTRACT

A printer configured to cut recording paper with a fixed blade and a movable blade has a push member configured to push out the movable blade or racks provided at both longitudinal ends of the movable blade, to expose a blade of the movable blade, and the push member is fixed in position while the blade is exposed.

### CROSS-REFERENCE TO RELATED APPLICATION

This application is based upon and claims priority to Japanese Patent Application No. 2021-106962, filed on Jun. 28, 2021, the entire contents of which are incorporated herein by reference.

### TECHNICAL FIELD

Certain aspects of the embodiments are related to a printer.

### BACKGROUND

Printers are used in applications such as automated teller machines, ticket-issuing machines, kiosk terminals, and so forth. Some printers use a cutter to cut the recording paper.

Some printers have a printer's main body and a cover that is rotatably supported by the main body, and a roll of recording paper can be set in the main body by opening the cover. In this case, for example, a print head is provided in the main body, and a platen roller is provided in the cover. By closing the cover, the recording paper is positioned between the print head and the platen roller, and printing is performed.

Some cutters provided in printers have a movable blade and a fixed blade, and cut the recording paper between the movable blade and the fixed blade by moving the movable blade towards the fixed blade.

### RELATED ART

[Patent Document 1] Japanese Unexamined Patent Application Publication No. 2004-237555

[Patent Document 2] Japanese Unexamined Patent Application Publication No. 2006-312321

### SUMMARY

According to the embodiments of the present invention, a printer configured to cut recording paper with a fixed blade and a movable blade includes a push member configured to push out the movable blade or racks provided at both longitudinal ends of the movable blade to expose a blade of the movable blade, and the push member is fixed in position while the blade is exposed.

### BRIEF DESCRIPTION OF DRAWINGS

FIG. 1 is a cross-sectional view of a printer according to the embodiments of the present invention;

FIG. 2 is a perspective view of the printer with the cover open;

FIG. 3 is a perspective view of the printer with the cover closed;

FIG. 4 is a plan view of a push mechanism according to a first embodiment;

FIG. 5 is a plan view of the push mechanism according to the first embodiment;

FIG. 6 is a plan view of the push mechanism according to the first embodiment;

FIG. 7 is a perspective view of the push mechanism according to the first embodiment;

FIG. 8 is a perspective view of the push mechanism according to the first embodiment;

FIG. 9 is a cross-sectional view of the push mechanism according to the first embodiment;

FIG. 10 is a cross-sectional view of the push mechanism according to the first embodiment;

FIG. 11 is a plan view of a movable blade according to the first embodiment;

FIG. 12 is a plan view of a push mechanism according to a second embodiment;

FIG. 13 is a plan view of the push mechanism according to the second embodiment;

FIG. 14 is a perspective view of the push mechanism according to the second embodiment;

FIG. 15 is a plan view of a push mechanism according to a third embodiment;

FIG. 16 is a plan view of the push mechanism according to the third embodiment;

FIG. 17 is a perspective view of the push mechanism according to the third embodiment;

FIG. 18 is a perspective view of the push mechanism according to the third embodiment;

FIG. 19 is a plan view of a movable blade according to the third embodiment;

FIG. 20 is a plan view of a push mechanism according to a fourth embodiment;

FIG. 21 is a plan views of the push mechanism according to the fourth embodiment;

FIG. 22 is a perspective view of the push mechanism according to the fourth embodiment;

FIG. 23 is a perspective view of the push mechanism according to the fourth embodiment;

FIG. 24A is a cross-sectional view of the push mechanism according to the fourth embodiment;

FIG. 24B is a cross-sectional view of the push mechanism according to the fourth embodiment;

FIG. 25A is a cross-sectional view of the push mechanism according to the fourth embodiment;

FIG. 25B is a cross-sectional view of the push mechanism according to the fourth embodiment;

FIG. 26 is a plan view of a movable blade according to the fourth embodiment;

FIG. 27 is a plan view of a push mechanism according to a fifth embodiment;

FIG. 28 is a plan view of the push mechanism according to the fifth embodiment;

FIG. 29 is a cross-sectional view of the push mechanism according to the fifth embodiment; and

FIG. 30 is a cross-sectional view of the push mechanism according to the fifth embodiment.

### DESCRIPTION OF EMBODIMENTS

Now, non-limiting example embodiments of the present invention will be described below with reference to the accompanying drawings. In all of the drawings attached herewith, the same or corresponding members or parts will be assigned the same or corresponding reference numerals, and redundant description will be omitted.

In the drawings, the X direction will refer to the longitudinal direction of the movable blade according to the embodiments of the present invention. The Y direction will refer to the lateral direction that runs along the surface of the movable blade. The Z direction will refer to the direction that is orthogonal to both the X axis and the Y axis.

The direction in which the arrow points along the X direction will be referred to as “+X,” and the opposite direction of the +X direction will be referred to as the “−X.” The direction in which the arrow points along the Y direction will be referred to as “+Y,” and the opposite direction of the +Y direction will be referred to as “−Y.” The direction in which the arrow points along the Z direction will be referred to as “+Z,” and the opposite direction of the +Z direction will be referred to as “−Z.”

A cutter may become stained after repeated cuttings of recording paper. The cutter is unable to cut recording paper while in such a condition, and therefore needs to be cleaned regularly. However, cleaning a movable blade is not easy. After the drive gear to allow the movable blade to rotate is turned with fingers or the like and the movable blade is exposed, the movable blade is cleaned whilst holding the drive gear with fingers or the like to keep the movable blade exposed.

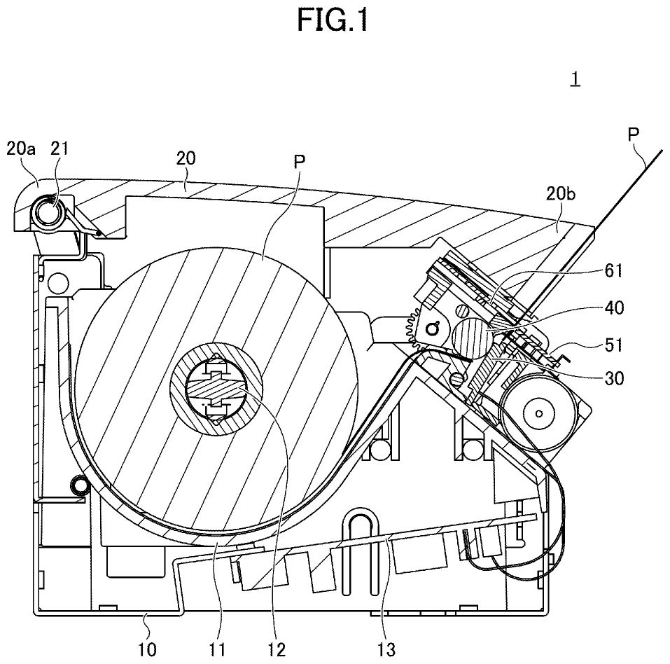

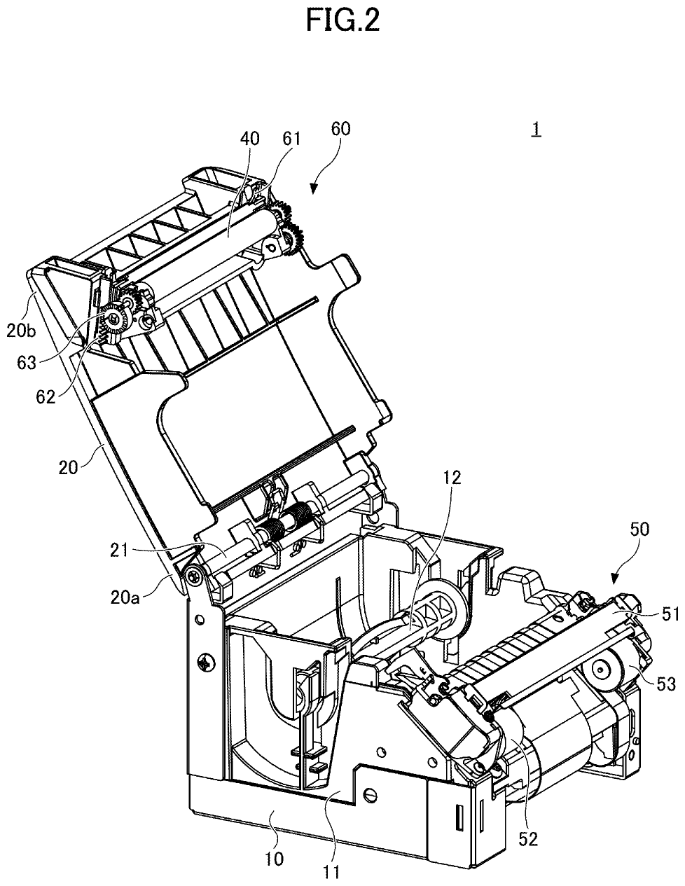

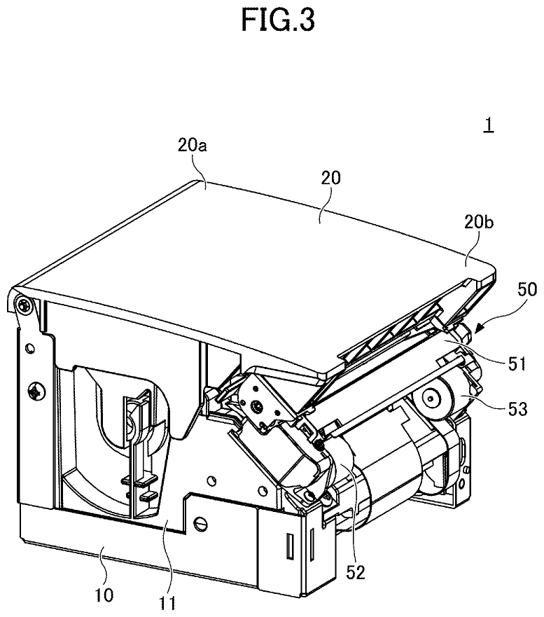

FIG. 1 is a cross-sectional view of a printer according to the embodiments of the present invention. FIG. 2 is a perspective view of the printer 1 with the cover open. FIG. 3 is a perspective view of the printer 1 with the cover closed. An example of the printer according to the embodiments of the present invention will be described below with reference to FIG. 1 to FIG. 3.

The printer 1 is a clamshell-type printer, and includes a main body 10 and a cover 20. In the main body 10, a holder 11 for setting roll-shaped recording paper P is formed. The cover 20 is an example of a housing. One end portion 20a of the cover 20 is joined with the main body 10 such that the cover 20 can be opened and closed. The cover 20 is joined with the main body 10 via a rotation shaft 21 that is provided near the end portion 20a. The cover 20 can be opened and closed by rotating the cover 20 about the rotation shaft 21.

A feed shaft 12 that supports the recording paper P is set inside the holder 11, and the cover 20 is closed as shown in FIG. 3. This places the recording paper P in a state ready for printing. Note that FIG. 1 shows a state in which the recording paper P is supported by the feed shaft 12, and FIG. 2 shows a state in which no recording paper P is supported by the feed shaft 12.

A print head 30 is provided as a print head in the main body 10, and a platen roller 40 is provided in the cover 20. A fixed blade unit 50, including a fixed blade 51, is attached to the main body 10, and a movable blade unit 60 (hereinafter “blade unit”), including a movable blade 61, is attached to the cover 20 such that the blade unit 60 can be attached and removed. In the main body 10, a motor 52 for rotating the platen roller 40 to transport the recording paper P and a motor 53 for driving the movable blade 61 are provided. Note that the platen roller 40 and the movable blade 61 are provided near the end portion 20b of the cover 20.

When the cover 20 is closed, the recording paper P is positioned between the print head 30 and the platen roller 40, and the recording paper P is sandwiched between the fixed blade 51 and the movable blade 61. Closing the cover 20 places the fixed blade 51 and the movable blade 61 at predetermined positions, and places the recording paper P in a state ready for cutting. Note that a control board 13 for controlling the printer 1 is provided outside the main body 10.

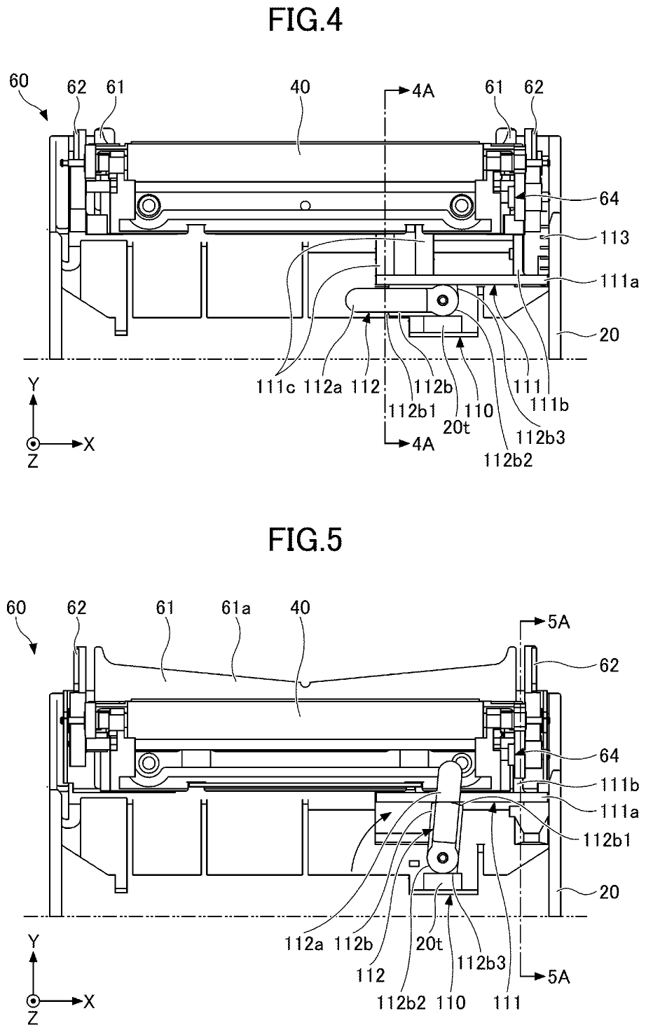

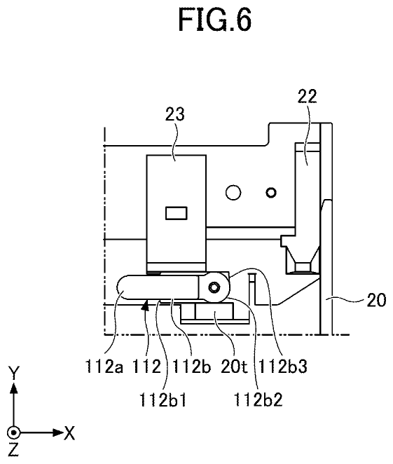

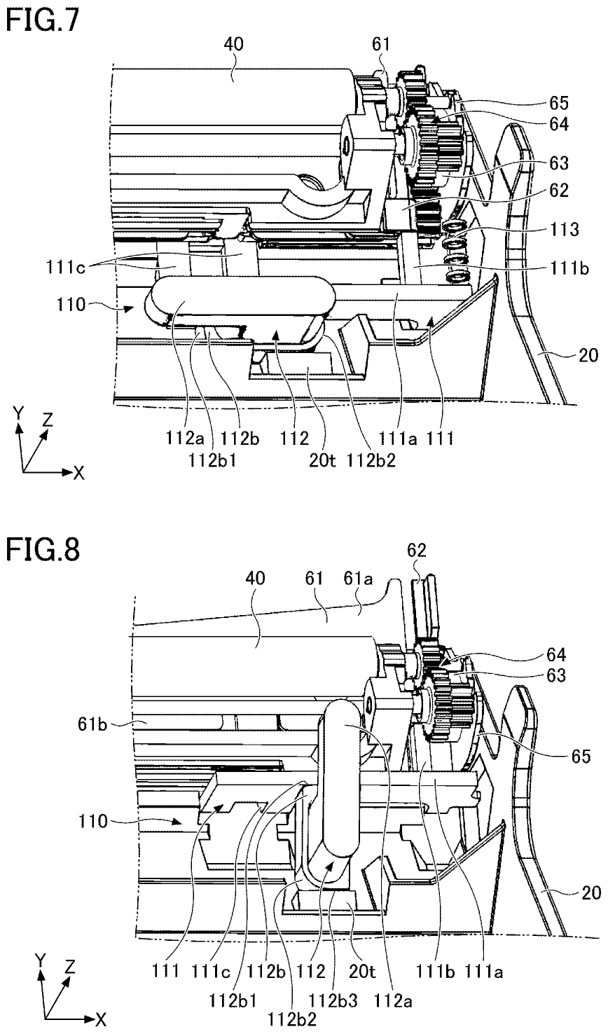

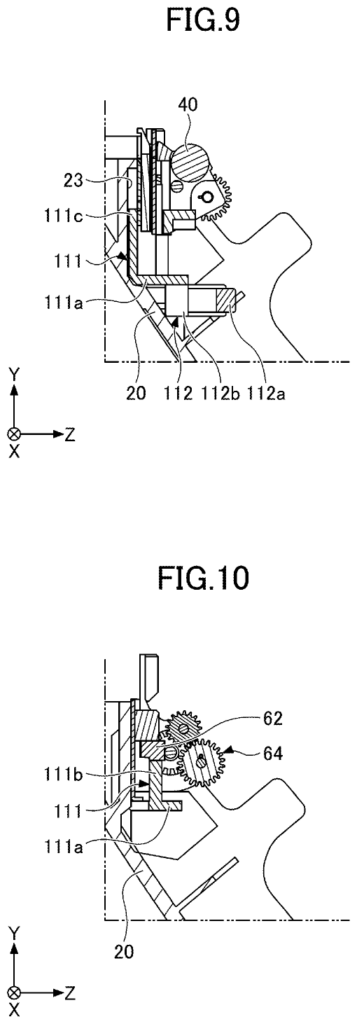

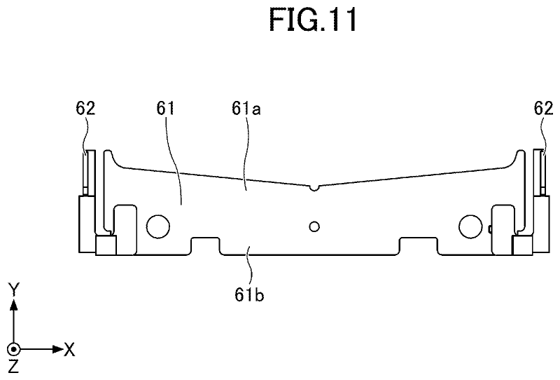

The first embodiment of the push mechanism will be described below with reference to FIG. 4 to FIG. 11. FIG. 4 is a plan view of a printer in a state in which the blade of a movable blade is not exposed. FIG. 5 is a plan view of the printer in a state in which the blade of the movable blade is exposed. FIG. 6 is a plan view for explaining a guiding groove. FIG. 7 is a perspective view of the printer with an unexposed blade. FIG. 8 is a perspective view of the printer with an exposed blade. FIG. 9 is a cross-sectional view of the printer with an unexposed blade, taken along line 4A-4A in FIG. 4. FIG. 10 is a cross-sectional view of the printer with the blade part of the movable blade exposed, taken along line 5A-5A in FIG. 5. FIG. 11 is a plan view of the movable blade attached to racks.

The blade unit 60 includes a movable blade 61, racks 62, pinions 63, a gear train 64, a frame 65, and a platen roller 40.

The movable blade 61 is made of a material such as metal. The movable blade 61 has a V-shaped blade 61a, and an end portion 61b, which is located opposite from the blade 61a. The racks 62 are attached to both end portions of the movable blade 61.

The racks 62 are connected with the pinions 63. Also, the pinions 63 are connected with the gear train 64. The gear train 64 includes multiple gears, and is connected with gears on the motor 53 side and the like, with the cover 20 closed. The pinions 63 allow the racks 62 to move in the Y direction in conjunction with the rotation of the gear train 64. The frame 65 supports the pinions 63 and the gear train 64 in a pivotable fashion.

With the cover 20 closed, the rotation of the motor 53 is transmitted to the pinions 63 via the gear train 64, and the pinions 63 rotate. This rotation is then transmitted to the racks 62, and the movable blade 61, in unison with the racks 62, moves linearly in the Y direction. By this means, the movable blade 61 is allowed to move in the +Y direction and cut the recording paper P. Meanwhile, when the cover 20 is opened, the gears on the motor 53 side and the gear train 64 are disconnected. The movable blade 61 is urged in the −Y direction by elastic components such as springs (not shown). When the gears on the motor 53 side and the gear train 64 are disconnected, the movable blade 61 is accommodated in the blade unit 60 by the urging force of the springs, placing the blade 61a in an unexposed state.

The push mechanism 110 includes a push member 111, a lever 112, and a coiled spring 113.

The push member 111 pushes out the racks 62, moves the movable blade 61 in the +Y direction in unison with the racks 62, and exposes the blade 61a. In this embodiment, the push member 111 includes a contact part 111a, a press part 111b, and guides 111c.

The contact part 111a has a rectangular flat shape, with its longitudinal direction aligned with the X direction, and its −Y surface can contact the lever 112.

The press part 111b has a rectangular flat shape that extends in the +Y direction from the +Y surface of the contact part 111a, and its tip on the +Y side can contact the −Y ends of the racks 62. The press part 111b is guided by a guiding groove 22 formed on the inner surface of the cover 20.

The guides 111c have a rectangular flat shape that extends in the +Y direction from the +Y surface of the contact part 111a, and is guided by a groove 23 formed on the inner surface of the cover 20.

The lever 112 is provided on the inner surface of the cover 20 in a rotatable fashion, about the Z axis as the axis of rotation, and includes a handle 112a and a press part 112b.

The handle 112a is provided on the +Z side of the press part 112b, and constitutes a portion for gripping the lever 112 between fingers or in the palm (hereinafter collectively referred to as “hand/fingers”). The shape of the handle 112a is not limited, and is, for example, a rectangular flat shape with chamfered end portions.

The press part 112b rotates with the handle 112a. The shape of press part 112b is not limited, and is, for example, a rectangular flat shape, the longitudinal direction of which is aligned with the same direction as the longitudinal direction of the handle 112a, and the lateral direction of which is aligned with the lateral direction of the handle 112a. The press part 112b includes a press surface 112b1, an arc surface 112b2, and a flat surface 112b3.

The press surface 112b1 is provided at the +Y end of the press part 112b in FIG. 8. When the tip of the handle 112a rotates clockwise from the −X side in FIG. 7 to the +Y side in FIG. 8, the press part 112b rotates clockwise with the handle 112a, and, given this rotation of the press part 112b, the contact part 111a is pushed out in the +Y direction by the press surface 112b1. By this means, as the press part 111b and the guide 111c are guided by the groove 22 and the groove 23, respectively, the push member 111 moves in the +Y direction.

The arc surface 112b2 is provided on the −X side of the −Y end of the press part 112b.

The flat surface 112b3 is provided on the +X side of the −Y end of the press part 112b. When the tip of the handle 112a rotates clockwise from the −X side to the +Y side, as shown in FIG. 8, the position of the handle 112a is rotated from the position shown in FIG. 7 by 90 degrees or approximately 90 degrees, and thereupon the flat surface 112b3 is brought into contact with a projection part 20t on the inner surface of the cover 20, and the lever 112 is prevented from rotating.

The +Y end of the spring 113 is fixed to the frame 65, and the −Y end is fixed on the +Y side of the contact part 111a. The spring 113 preloads the push member 111 in the −Y direction. When the tip of the handle 112a rotates counterclockwise from the +Y side to the −X side, given the preloading force of the spring 113, the push member 111 moves in the −Y direction.

When the push member 111 moves in the +Y direction in response to the clockwise rotation of the lever 112, the press part 111b is brought into contact with the racks 62, and pushes out the racks 62 in the +Y direction. By this means, the movable blade 61 moves in the +Y direction in unison with the racks 62, and the blade 61a is exposed. Furthermore, in the state in which the lever 112 is rotated, the flat surface 112b3 is in contact with the projection part 20t, so that the lever 112 is prevented from rotating. As a result of this, the push member 111 is prevented from moving in the −Y direction, and the push member 111 is fixed in position.

As described above, according to the printer with the push mechanism 110, the push member 111 moves in the +Y direction in response to the rotation of the lever 112. Then, the racks 62 are pushed out in the +Y direction by the moving push member 111, and the blade 61a is exposed. Thus, the user can expose the blade 61a without touching the movable blade 61, the gear train 64, or the like with his/her hand/fingers, and without using a tool or the like. Furthermore, the push member 111 and the racks 62 are fixed in the state in which the lever 112 is rotated, so that the blade 61a can be held in an exposed state. As a result of this, the movable blade 61 can be cleaned with ease.

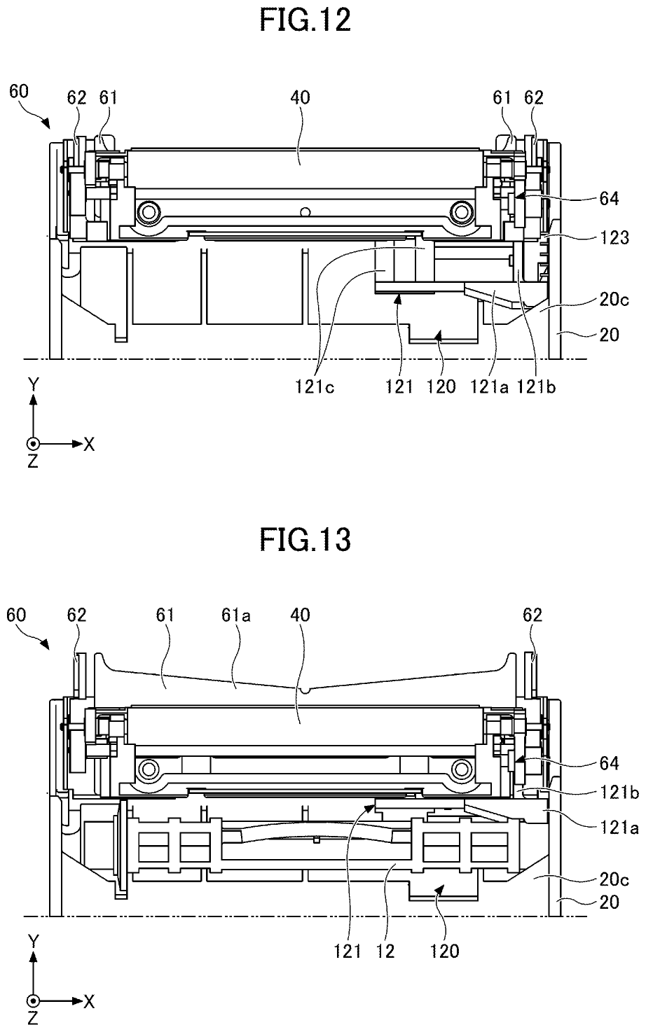

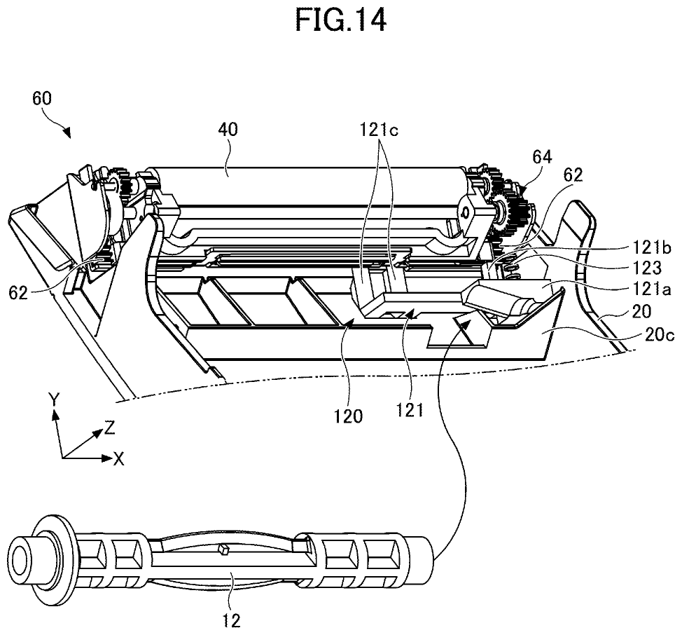

A second embodiment of the push mechanism will be described below with reference to FIG. 12 to FIG. 14. FIG. 12 is a plan view of the printer with the movable blade unexposed, and FIG. 13 is a plan view of the printer with the movable blade exposed. FIG. 14 is a perspective view of the printer with an unexposed blade.

The push mechanism 120 according to the second embodiment includes a push member 121, a feed shaft 12, and a coil spring 123. As shown in FIG. 2, the feed shaft 12 is provided inside the holder 11, and removed from the holder 11 when the push member 121 is operated. The movable blade 61 is often cleaned when the recording paper P runs out, and therefore there is no problem in removing the feed shaft 12 when cleaning the movable blade 61.

The push member 121 pushes out the racks 62 and moves the movable blade 61 in the +Y direction in unison with the racks 62, thereby exposing the blade 61a. The push member 121 includes a hold part 121a, a press part 112b, and guides 121c. When the feed shaft 12 is fitted between the hold part 121a and a rib 20c formed on the inner surface of the cover 20, the hold part 121a is pressed by the feed shaft 12 and moves in the +Y direction. The press part 112b is configured to press the racks 62, and has a rectangular flat shape that extends in the +Y direction from the +Y surface of the hold part 121a, and its tip on the +Y side can contact the −Y ends of the racks 62. Similar to the press part 111b, the press part 112b is guided by a groove (not shown) formed on the inner surface of the cover 20. The guides 121c have a rectangular flat shape that extends in the +Y direction from the +Y surface of the hold part 121a, and, similar to the guides 111c, are guided by a groove (not shown) formed on the inner surface of the cover 20.

When the feed shaft 12 is fitted between the hold part 121a and the rib 20c, the push member 121, pressed by the feed shaft 12, moves in the +Y direction. By this means, the racks 62 are pushed out in the +Y direction, and the movable blade 61 moves with the racks 62 in the +Y direction. Furthermore, when the feed shaft 12 is fitted between the hold part 121a and the rib 20c, the push member 121 is prevented from moving in the −Y direction, and the push member 121 is fixed in position.

As described above, according to the printer with the push mechanism 120, when the feed shaft 12 is fitted between the hold part 121a and the rib 20c, the push member 121 moves in the +Y direction, and the racks 62 are pushed out in the +Y direction by the push member 121, thereby exposing the blade 61a. Thus, the user can expose the blade 61a without touching the movable blade 61, the gear train 64, or the like with his/her hand/fingers, and without using a tool or the like. Furthermore, when the feed shaft 12 is fitted between the hold part 121a and the rib 20c, the push member 111 and the racks 62 are fixed, so that the blade 61a can be held in an exposed state. As a result of this, the movable blade 61 can be cleaned with ease.

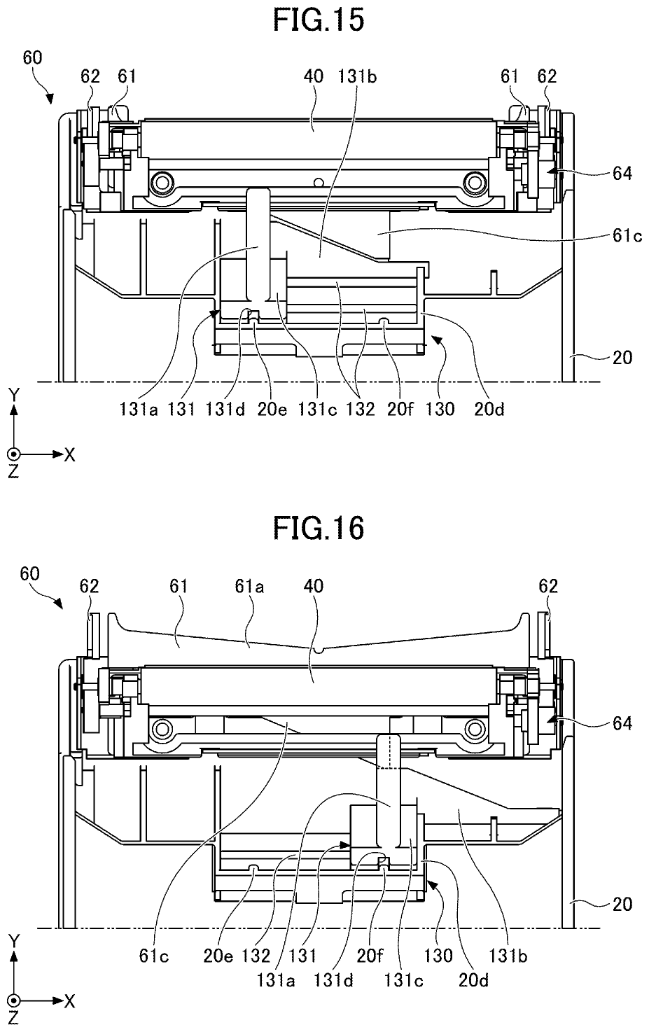

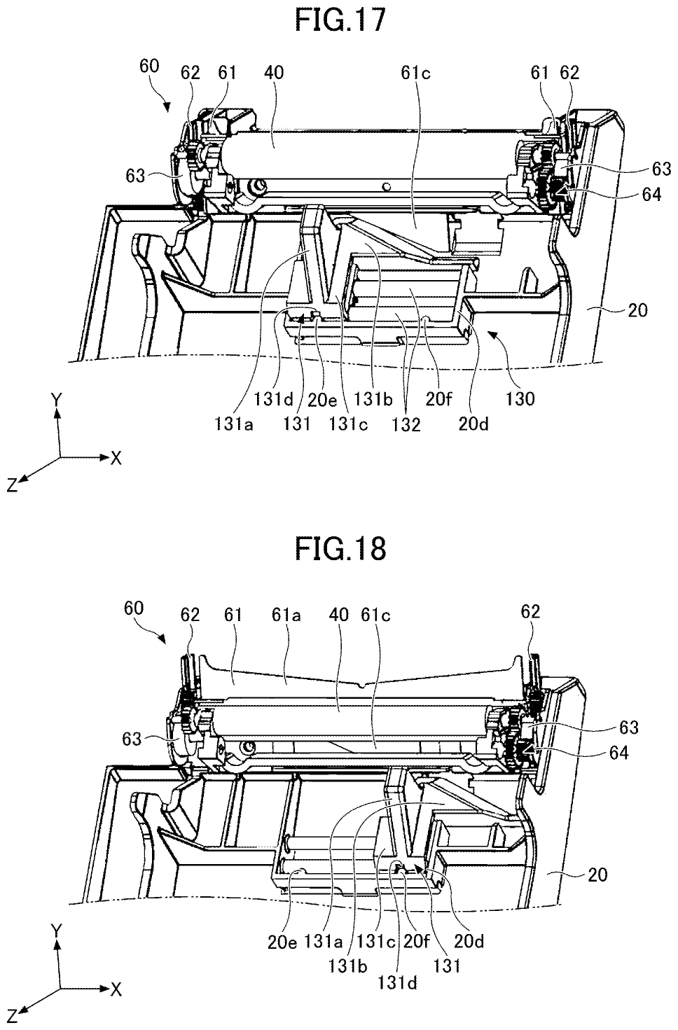

A third embodiment of the push mechanism will be described below with reference to FIG. 15 to FIG. 19. FIG. 15 is a plan view of the printer with an unexposed blade, and FIG. 16 is a plan view of the printer with an exposed blade. FIG. 17 is a perspective view of the printer with an unexposed blade, and FIG. 18 is a perspective view of the printer with an exposed blade. FIG. 19 is a plan view of the movable blade.

In accordance with the third embodiment, the movable blade 61 has a V-shaped blade 61a, an end portion 61b located opposite from the blade 61a, and a projection part 61c protruding from the end portion 61b in the −Y direction. The projection part 61c has an inclined surface that is inclined towards the −Y side, from the −X side to the +X side.

The push mechanism 130 includes a push member 131 and guide rails 132.

The push member 131 pushes out the movable blade 61 by moving in the +X direction. The push member 131 includes a handle 131a, a press part 131b, and guides 131c.

The handle 131a is provided at the +Z side of the guide 131c, and can be held by a hand/fingers or the like to move the push member 131 in the X direction.

The press part 131b is provided on the +Y side of the guide 131c. The press part 131b has an inclined surface that is inclined towards the −Y side, from the −X side to the +X side, and that engages with the inclined surface of the projection part 61c.

The guides 131c are guided by rails 132 formed on the inner surface of the cover 20 along the X direction. In the guide 131c, a recess 131d is formed to engage with protrusions 20e and 20f that are provided in the rib 20d formed on the inner surface of the cover 20. While the guide 131c is located at the −X end, the guide 131c is fixed in position as the protrusion 20e and the recess 131d engage with each other. On the other hand, while the guide 131c is located at the +X end, the guide 131c is fixed in position as the protrusion 20f and the recess 131d engage with each other.

The rails 132 are attached to the rib 20d. The rails 132 guide the movement of the guide 131c in the X direction.

When the push member 131 moves in the +X direction in response to the handle 131a moving in the +X direction, the press part 131b contacts and presses the projection part 61c, and pushes out the movable blade 61 in the +Y direction. By this means, the blade 61a is exposed. Also, in the state in which the push member 131 is moved to the right end, the protrusion 20f and the recess 131d are engaged with each other, and the push member 131 is fixed in position.

As described above, according to the printer with the push mechanism 130, when the push member 131 moves in the +X direction and the movable blade 61 is pushed out in the +Y direction, the blade part 61a is exposed. Thus, the user can expose the blade 61a without touching the movable blade 61, the gear train 64, or the like with his/her hand/fingers, and without using a tool or the like. Also, in the state in which the push member 131 is moved to the right end, the protrusion 20f and the recess 131d are engaged with each other to fix the push member 131, so that the blade 61a can be held in an exposed state. As a result of this, the movable blade 61 can be cleaned with ease.

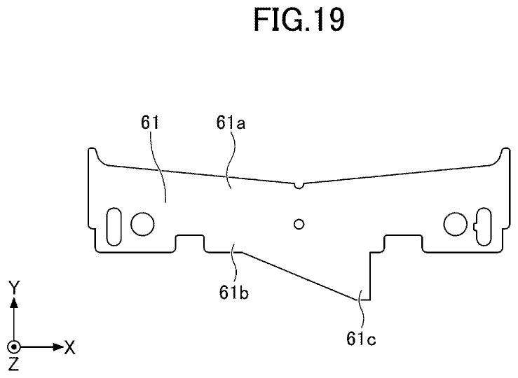

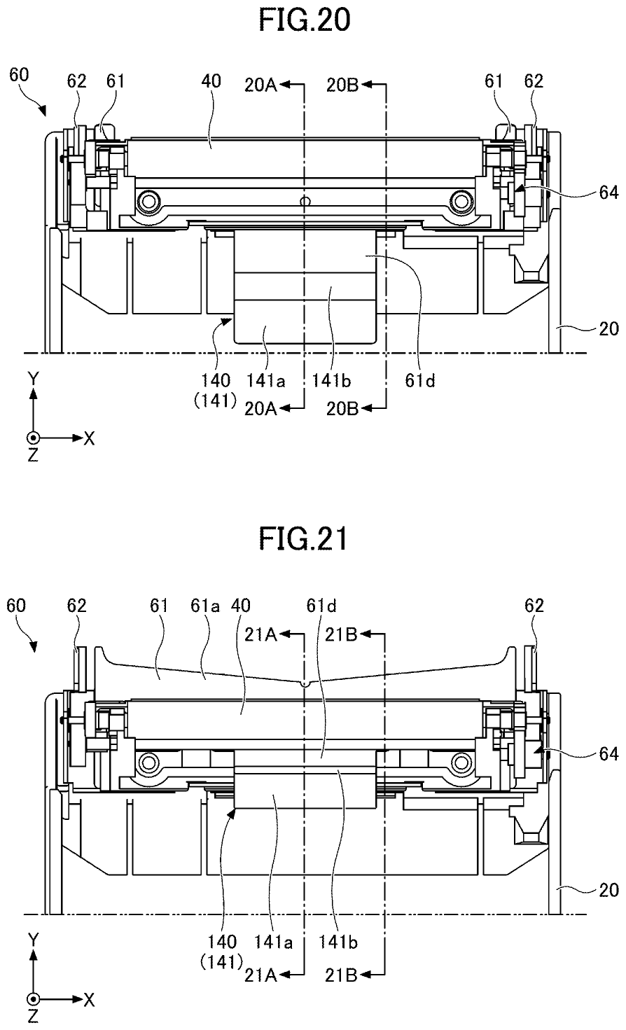

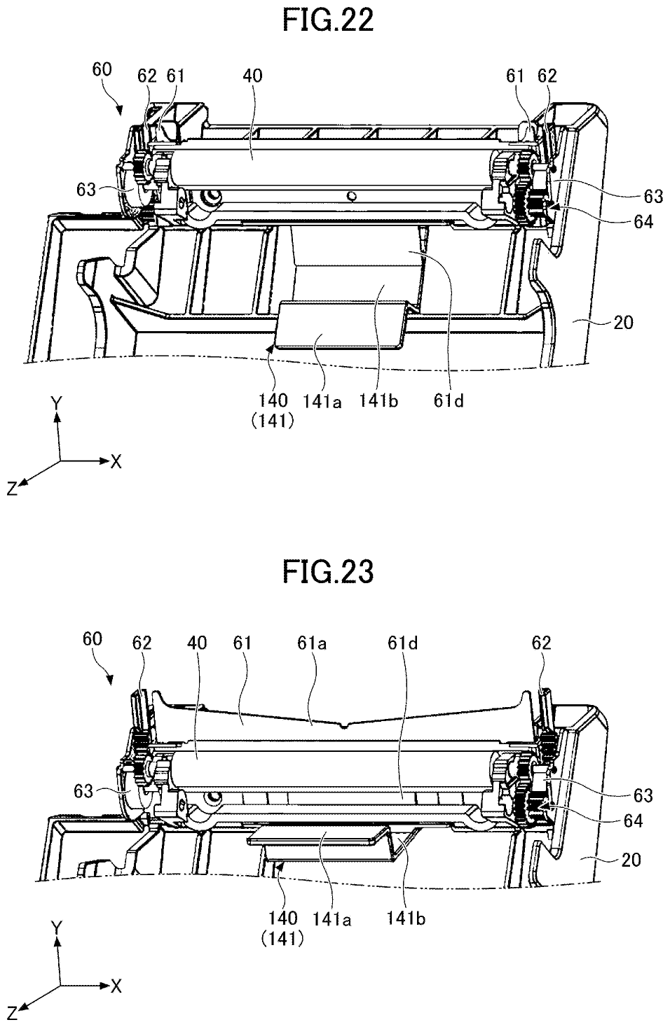

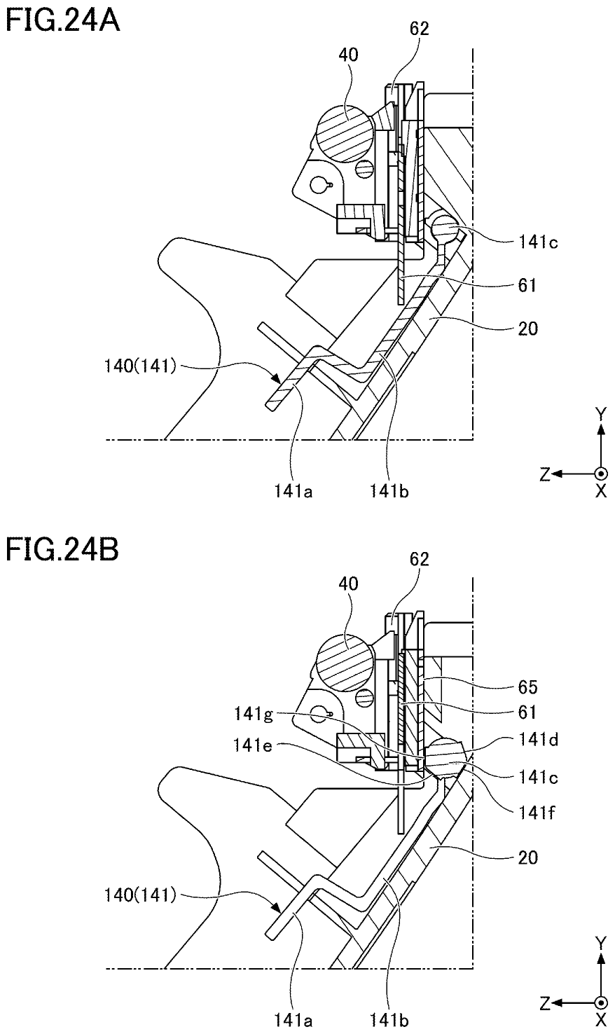

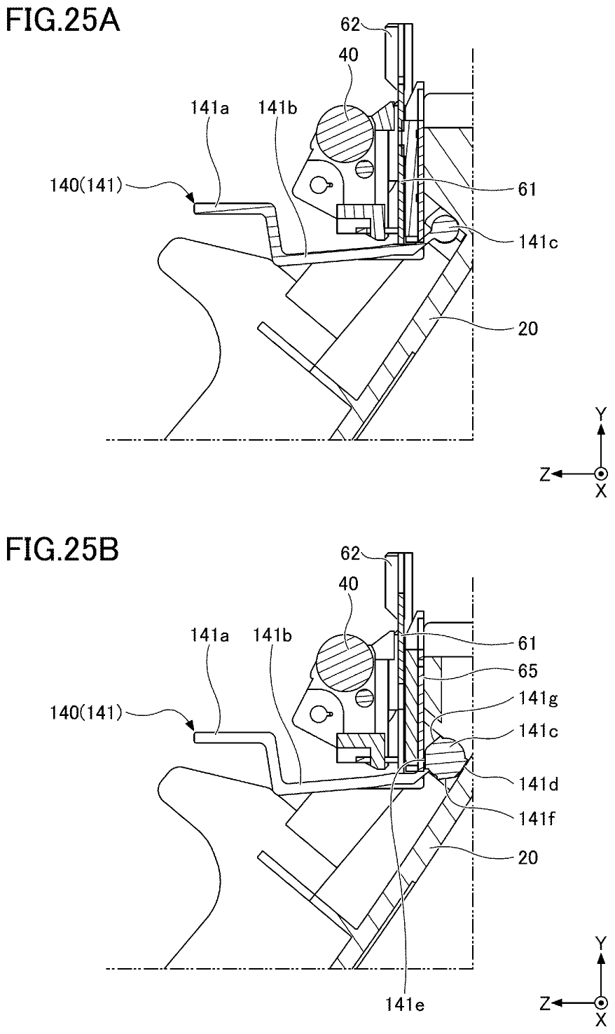

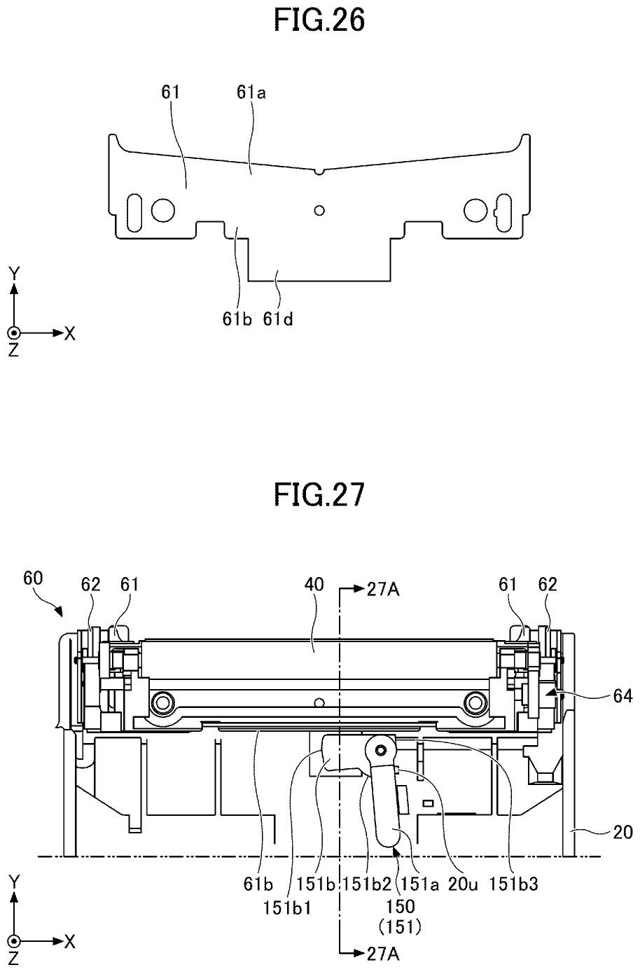

A fourth embodiment of the push mechanism will be described below with reference to FIG. 20 to FIG. 26. FIG. 20 is a plan view of the printer with an unexposed blade, and FIG. 21 is a plan view of the printer with an exposed blade. FIG. 22 is a perspective view of the printer with an unexposed blade, and FIG. 23 is a perspective view of the printer with an exposed blade. FIGS. 24A and 24B are cross-sectional views of the printer with an unexposed blade, where FIG. 24A is a cross-sectional view taken along line 20A-20A in FIG. 20, and FIG. 24B is a cross-sectional view taken along line 20B-20B in FIG. 20. FIGS. 25A and 25B are cross-sectional views of the printer with an exposed blade, where FIG. 25A is a cross-sectional view taken along line 21A-21A in FIG. 21, and FIG. 25B is a cross-sectional view taken along line 21B-21B in FIG. 21. FIG. 26 is a plan view of the movable blade.

In accordance with the fourth embodiment, the movable blade 61 has a V-shaped blade 61a, an end portion 61b, located opposite from the blade 61a, and a projection part 61d protruding in the −Y direction from the end portion 61b. The projection part 61d has, for example, a rectangular flat shape that protrudes towards the −Y side in the center portion of the movable blade 61.

The push mechanism 140 includes a push member 141.

The push member 141 rotates about the X axis as the axis of rotation, and pushes out the movable blade 61. In this embodiment, the push member 141 includes a handle 141a, a press part 141b, and a shaft 141c.

The handle 141a constitutes a portion for gripping the push member 141 by a hand/fingers or the like. The shape of the handle 141a is not limited, and is, for example, L-shaped. The handle 141a is bent from the −Z end to the −Y side of a rectangular plate, whose longitudinal direction is aligned with the X direction, and connected to the +Z end of the press part 141b.

The press part 141b has a flat shape, and the shaft 141c is connected to its −Z end. The press part 141b contacts the projection part 61d, and pushes out the movable blade 61 in the +Y direction.

The shaft 141c is a rod-shaped part that extends in the X direction, and can rotate about the X axis as the axis of rotation. Both end portions of the shaft 141c are formed in a polygonal shape having flat parts 141d to 141g in the outer peripheral portions, and act as cams. While the handle 141a is unlifted, the flat part 141f of the shaft 141c is in contact with the inner surface of the cover 20, and the flat part 141g is in contact with the frame 65, so that the rotation is fixed.

When the handle 141a is lifted up from the cover 20, the press part 141b rotates about the shaft 141c as the center of rotation, and the press part 141b is brought into contact with the projection part 61c, and pushes out the movable blade 61 in the +Y direction. By this means, the blade 61a is exposed. Furthermore, while the handle 141a is lifted, the flat part 141d is in contact with the inner surface of the cover 20, and the flat part 141e is in contact with the frame 65, so that the push member 141 is prevented from rotating, and the movable blade 61 is fixed.

As described above, according to the printer with the push mechanism 140, when the press part 151b rotates in response to the lifting operation of the handle 141a, and the movable blade 61 is pushed out in the +Y direction by the press part 151b, the blade 61a is exposed. Thus, the user can expose the blade 61a without touching the movable blade 61, the gear train 64, or the like with his/her hand/fingers, and without using a tool or the like. Furthermore, the movable blade 61 is fixed with the handle 141a lifted, so that the blade 61a can be held in an exposed state. As a result of this, the movable blade 61 can be cleaned with ease.

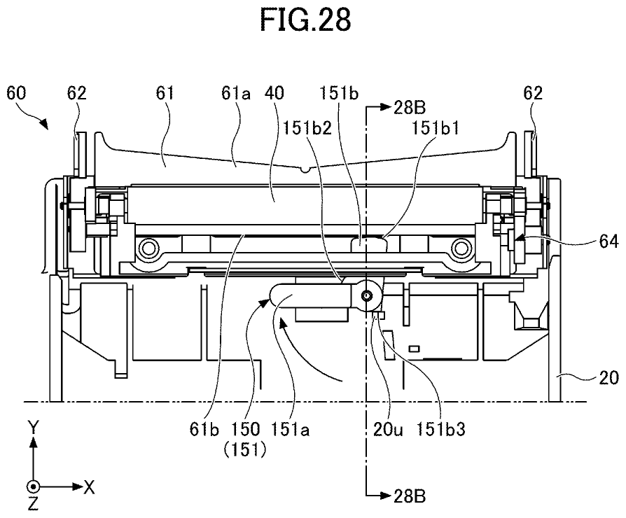

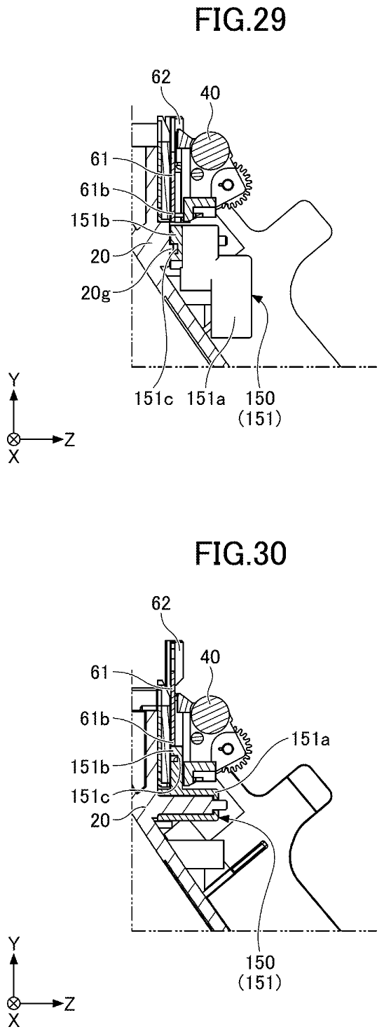

A fifth embodiment of the push mechanism will be described below with reference to FIG. 27 to FIG. 30. FIG. 27 is a plan view of the printer with an unexposed blade, and FIG. 28 is a plan view of the printer with an exposed blade. FIG. 29 is a cross-sectional view of the printer with an unexposed blade, taken along line 27A-27A in FIG. 27. FIG. 30 is a cross-sectional view of the printer with an exposed blade, taken along line 28A-28A in FIG. 28.

The push mechanism 150 includes a push member 151.

The push member 151 rotates about the Z axis as the axis of rotation, and pushes out the movable blade 61. The push member 151 includes a handle 151a and a press part 151b.

The handle 151a is provided on the inner surface of the cover 20 in a rotatable fashion, and constitutes a portion for gripping the push member 151 by a hand/fingers.

The press part 151b is provided on the inner surface of the cover 20, with the handle 151a, in a rotatable fashion. At the −Z end of the press part 151b, a recess 151c is formed to engage with the protrusion 20g formed on the inner surface of the cover 20. While the handle 151a is in the position before rotation, the protrusion 20g and the recess 151c are engaged with each other, and the push member 151 is fixed. The shape of the press part 151b is not limited, and may be, for example, a rectangular flat shape, whose longitudinal direction is aligned with the lateral direction of the handle 151a, and whose lateral direction is aligned with the longitudinal direction of the handle 151a. The press part 151b includes a press surface 151b1, an arc surface 151b2, and a flat surface 151b3.

The press surface 151b1 is provided at the +Y end of the press part 151b. When the handle 151a rotates clockwise from the −Y side in FIG. 27 to the −X side in FIG. 28, the press part 151b rotates clockwise with the handle 151a, and the tip part 61b is pushed out in the +Y direction by the press surface 151b1.

The arc surface 151b2 is provided on the −X side of the −Y end of the press part 151b.

The flat surface 151b3 is provided on the +X side of the −Y end of the press part 151b. When the handle 151a rotates clockwise from the −Y side to the −X side, the press part 151b is positioned as shown in FIG. 28, which is rotated from the position shown in FIG. 27 by 90 degrees or approximately 90 degrees, and thereupon the flat surface 151b3 is brought into contact with the projection part 20u on the inner surface of the cover 20, and the push member 151 is prevented from rotating.

When the press part 151b rotates in response to the rotation of the handle 151a, the press part 151b is brought into contact with the end portion 61b, and pushes out the movable blade 61 in the +Y direction. This exposes the blade 61a. Furthermore, in the state in which the handle 151a is rotated, the flat surface 151b3 is in contact with the projection part 20u, so that the push member 151 is prevented from rotating. As a result of this, the movable blade 61 is prevented from moving in the −Y direction, and the movable blade 61 is fixed in position.

As described above, according to the printer with the push mechanism 150, when the press part 151b rotates in response to the rotation of the handle 151a, the movable blade 61 is pushed out in the +Y direction, and the blade 61a is exposed. Thus, the user can expose the blade 61a without touching the movable blade 61, the gear train 64, or the like with his/her hand/fingers, and without using a tool or the like. Further, the movable blade 61 is fixed in the state in which the handle 151a is rotated, so that the blade 61a can be held in an exposed state. As a result of this, the movable blade 61 can be cleaned with ease.

The embodiments described herein are examples in all aspects, and should not be construed as limitations. A variety of omissions, replacements, and changes can be made to the above embodiments, in various forms, within the scope of the present invention as recited in the following claims.

What is claimed is:

1. A printer configured to cut recording paper with a fixed blade and a movable blade, the printer comprising:
a push member configured to push out the movable blade or racks provided at both longitudinal ends of the movable blade, to expose a blade of the movable blade,
wherein the push member is fixed in position while the blade is exposed.

2. The printer according to claim 1, further comprising:
a housing configured to house a blade unit including the movable blade; and
a lever provided on an inner surface of the housing in a rotatable fashion,
wherein the push member pushes out the racks in response to rotation of the lever.

3. The printer according to claim 2, wherein
the lever has a flat surface, and
the rotation of the lever pushes out the push member and the flat surface contacts the housing, thereby fixing the lever in position.

4. The printer according to claim 1, further comprising:
a housing configured to house a blade unit including the movable blade; and
a feed shaft that supports the recording paper and is attachable in a removable fashion,
wherein the push member pushes out the racks upon fitting of the feed shaft in the housing.

5. The printer according to claim 1, wherein
the movable blade has a projection part with an inclined surface,
the push member has a push part with an inclined surface that contacts the inclined surface of the projection part, and
the push member pushes out the movable blade when the blade unit including the movable blade, following a guide rail provided in the housing, moves in a longitudinal direction of the movable blade.

6. The printer according to claim 1, further comprising:
a housing configured to house a blade unit including the movable blade,
wherein the push member has a push part provided in a rotatable fashion, with a longitudinal direction of the movable blade serving as an axis of rotation, and pushes out the movable blade in response to a lifting operation of the push member.

7. The printer according to claim 1, wherein the push member has a push part provided in a rotatable fashion, and pushes out the movable blade in response to a rotation of the push part.

8. The printer according to claim 5, further comprising:
a housing configured to house a blade unit including the movable blade, wherein
the push member has a recess, and
the push member is fixed in position upon engagement of a protrusion provided in the housing with the recess.
